(19) United States
(12) Patent Application Publication
(10) Pub. No.: US 2006/0199652 A1
(43) Pub. Date: Sep. 7, 2006

(54) Connection of two structural parts

(76) Inventor: Peter Fuhrmann, Lohmar (DE)

Correspondence Address: Robert P. Renke, Suite 250, 28333 Telegraph Road, Southfield, MI, 48034, US

(21) Appl. No.: 11/322,315

(22) Filed: Dec. 30, 2005

Related U.S. Application Data
(63) Continuation of application No. PCT/EP05/07744, filed on Jul. 15, 2005.

(30) Foreign Application Priority Data
Jul. 22, 2004 (DE) 102004035611.4-12

(51) Int. Cl. F16D 3/18

(52) U.S. Cl. 464/158

(57) ABSTRACT

A connection of a first structural part with a second structural part by a toothing, where the first structural part has internal toothing and the second structural part has external toothing. The internal toothing and/or the external toothing have straight toothing, in which only part of the toothing has a defined irregularity with respect to the remaining part of the toothing. The irregularity produces a force for the prevention of relative movement between the structural parts. In addition, tools as well as a method for the production of such a connection are provided.

### CROSS REFERENCE TO RELATED APPLICATION

This application is a continuation of and claims the benefit of PCT Application No. 2005/007744 filed on Jul. 15, 2005 entitled “Connection of Two Structural Parts.”

### TECHNICAL FIELD

The present invention relates to an articulated connection of a first structural part with a second structural part by a toothing, where the first structural part has internal toothing and the second structural part has external toothing.

### BACKGROUND OF THE INVENTION

U.S. Pat. No. 6,142,033, for example, discloses a shaft-hub connection in which an articulated connection capable of transmitting torque is procured by the connection between internal toothing and external toothing. The torque-transmitting shaft-hub unit disclosed is intended to make it possible to keep stresses on the shaft shank-side end of a toothing arrangement as low as possible.

Accordingly, it is desirable to have a toothing arrangement varied regionwise by enlargement of a root circle diameter toward the shaft shank to advantageously provide lower stresses on the shaft. Also, a transition between the regions may be achieved by a constant variation of the toothing arrangement. Moreover, an annular groove, which for example accommodates a round snap ring, may be provided for securing the hub axially on the shaft, thereby minimizing undesirable slipping of the hub on the shaft.

### SUMMARY OF THE INVENTION

The present invention provides an articulated connection of a first structural part with a second structural part by a toothing, which permits transmission of force with high axial securing of the positions of the two structural parts to each other.

A connection of a first structural part with a second structural part by a toothing is provided, where the first structural part has internal toothing and the second structural part has external toothing. The internal toothing and/or the external toothing have straight toothing, in which only part of the toothing has a defined irregularity with respect to the remaining part of the toothing. The irregularity produces a force for preventing relative movement between the structural parts.

In addition, tools as well as a method for the production of such a connection are provided.

The present invention has advantages by providing a connection of two structural parts. The present invention itself, together with further objects and intended advantages, will be best understood by reference to the following detailed description and taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows a first structural part having straight toothing and an irregularity in accordance with the present invention.

FIG. 2 shows a cross section through the first structural part as shown in FIG. 1.

FIG. 3 shows a second structural part having internal toothing with an irregularity in accordance with the present invention.

FIG. 4 shows a sectional view through the second structural part shown in FIG. 3.

FIG. 5 shows a tool in the form of a broaching needle for the production of a defined irregularity and toothing in accordance with the present invention.

FIG. 6 shows exemplary steps of a method for the production of an articulated connection of a first structural part and a second structural part in accordance with the present invention.

FIG. 7 shows a schematic detail of a rolling method for the production of a defined irregularity in accordance with the present invention.

FIG. 8 shows a connecting operation of a shaft 22 with a hub 23 in accordance with the present invention.

FIG. 9 shows a schematic view of a force variation of the force applied according to the connecting operation as shown in FIG. 8.

FIG. 10 shows a one-piece articulated part with internal toothing in accordance with the present invention.

FIG. 11 shows a partial cross-sectional view of the tripod of FIG. 12.

FIG. 12 shows a tripod having internal toothing with three irregularities in accordance with the present invention.

### DETAILED DESCRIPTION OF THE INVENTION

In the following description, various process parameters and components are described for one or more constructed embodiments. These specific parameters and components are included as examples and are not meant to be limiting.

In a first embodiment, an articulated connection of a first structural part with a second structural part by a toothing according to the invention provides that the first structural part has internal toothing and the second structural part has external toothing. The internal toothing and/or the external toothing is straight toothing, in which only part of the toothing has a defined irregularity with respect to the remaining part of the toothing, the irregularity producing a force for the prevention of relative movement between the structural parts.

The articulated connection can be used as a connection, fixed against rotation, between an axle shaft and an articulated structural part of a rotating joint in the drive train of a vehicle. In particular, the invention may find use in a Cardan shaft or drive shaft of a vehicle. For example, the articulated connection may be a component of a drive shaft of a vehicle or a component of a coupling. According to one embodiment, the proposed articulated connection may be utilized as a component of an electronically controlled torque management system or ETM (electronic torque management).

A toothing may for example be produced by broaching, by drawing or alternatively by rolling. For example, the toothing on a hub of the articulated connection can be produced by broaching, such as in the case of a spherical hub. A toothing on a shaft, for example, may be produced by a rolling or drawing process. Thus, different but, alternatively, the same production processes may be used on the shaft and hub. In particular, toothing may alternatively be produced in a single work step, by a single operation, for example by a die or by a broaching needle.

In this connection, according to the first embodiment, the straight toothing has a tolerance (T) per ISO 4156 in at least Class 5. In a refinement, a tolerance per Class 4 is alternatively obtained. In particular, a variation of the straight toothing of only up to at most two minutes is permitted. The variation of the straight toothing is permitted only to a degree predetermined by the tolerance. Otherwise, the toothing is produced in accordance with DIN 5480 and ANSI B92.1.

Because the toothing has a defined irregularity, stress in the articulated connection between the first structural part and the second structural part is produced in defined fashion. This stress prevents relative movement between the structural parts. In this way, the straight toothing of the first structural part improves the connection where the first structural part may not become loose from the second structural part when torque develops between the structural parts. In particular, the defined irregularity allows the articulated connection to be provided with toothing that does not require a helix. The straight toothing made possible in this way simplifies assembly of the first and second structural parts for production of the articulated connection.

The defined irregularity makes it possible to work with relative accuracy between the first and the second structural part in the remaining region of the toothing, which does not require classification of a toothing profile. As a result, in production a classification and assignment process of matching shafts and hubs to each other, for example, may be omitted. Optionally, however, the structural part may be at least partially subjected to classification. Moreover, the defined irregularity permits tightening of the two structural parts and hence fixed positioning may be accomplished.

Also, the irregularity may include an arrangement of one or more teeth and/or tooth gaps, which are arranged separated or at least adjacent in twos. Moreover, the irregularity can have a tooth and/or tooth gap whose geometries, in a particular flank, have another dimensioning in comparison with a tooth and/or tooth gap which is located outside the irregularity. The measures proposed below for obtaining the defined irregularity by a tooth may likewise be provided by a tooth gap and vice versa. Hence, an irregularity may be obtained by a targeted thickening or narrowing.

The irregularity may have a variation, which is in the range of 0.01 millimeter. According to the first embodiment, the precise variation of the irregularity may be designed independently of the modulus of the toothing. For example, toothings of a series with like or similar moduli may have approximately the same variation for production of the defined irregularity as toothings with moduli of a completely different kind. For example, a gap width of a toothing at the widest point is between 1.5 mm and 1.9 mm. Then an irregularity of the straight toothing is between 1/100 mm and 6/100 mm.

A narrowing or a thickening of an irregularity preferably is about 20 μm.

The number N of the teeth of a toothing, such as an external toothing, has a thicker tooth thickness. For example, the number N may be up to 50% of the total number of teeth. The value by which the teeth N are thickened is selected as a function of the number N. The greater the number N, the more teeth that transmit a force and provide for the prevention of relative movement between the structural parts. In this way, there is the possibility of being able, with increasing number N, to reduce a variation in dimensioning for obtaining a defined irregularity. An arrangement of the teeth that form the defined irregularity can be variable. Also, it may be selected in relation to the type of articulated connection. For example, the following various possibilities for uses to advantage with the first embodiment of the invention may, include, for example: each second tooth has another dimensioning, in particular, at least one region is thicker than an adjacent tooth; only one region of a tooth, such as a flank of a tooth, is varied in dimensioning for formation of the defined irregularity with respect to adjacent teeth; the tooth as a whole or only part of the tooth is varied, so that symmetrical teeth or asymmetrical teeth are produced for formation of the defined irregularity; a plurality of teeth that form a defined irregularity may be located alongside each other; individual teeth that form the defined irregularity may be located in the region of the toothing; a plurality of teeth or tooth regions, dimensioned differently in each instance, which form a defined irregularity of the toothing, may be provided; defined irregularities, displaced about 180° to each other in each instance, and thus located opposite each other, may be provided; pairwise teeth may form the irregularities; the irregularities are formed by adjacent teeth pairs, which in each instance are formed according to n=2 or n=3, the pairs being arranged by distributing around the periphery and opposite each other; or defined irregularities, which are an integral single or multiple of 2 or 3 in number, are distributed along the periphery, providing a pairwise arrangement of defined irregularities counting as one defined irregularity. The defined irregularities distributed over the periphery can have the same distance apart from each other. Optionally, the defined irregularities may be distributed unevenly over the periphery.

The defined irregularity may be provided in internal toothing as well as alternatively in external toothing.

According to a second embodiment, for example, a shaft-hub connection is provided as an articulated connection. In this embodiment, an arrangement or variation of modified teeth may be provided for formation of the defined irregularity on the external profile of the shaft or on the internal profile of the hub, as well as on both. According to this embodiment only one structural part, either the first structural part or the second structural part, i.e., only the hub or only the shaft, has the defined irregularity. Thus, upon assembly of the two structural parts, the definition of position of only one structural part in relation to the other need be checked.

Advantageously, when only one structural part has the defined irregularity, a controlled build-up of force between the parts is to be impressed with the irregularity. In another aspect, only the shaft toothing or only the hub toothing includes the defined irregularity. For example, the defined irregularity may be obtained by a special tooth shape, such as by a defined oversize of such a special tooth shape.

Optionally, the structural part can be a hollow shaft. The hollow shaft may have the toothing as internal toothing and/or as external toothing. Advantageously, two additional structural parts may be connected by the hollow shaft. In such a case, the hollow shaft alone may have the defined irregularities for both structural parts.

The position of the irregularity can be marked on the structural part. The structural part produced need not be held in a defined position at all times during the production process for production of the articulated connection between the first structural part and the second structural part. Rather, the irregularity is marked on the structural parts, the relative position of the first structural part to the second structural part can be checked according to pre-established parameters and any possible adjustment of position can be made before assembly. Moreover, the defined irregularity on a first structural part may be positioned to lie in a predefined position on the second structural part. Where the second structural part has a given dimensioning and shape, it may be designed so that the stress induced by a defined irregularity, which prevents relative movement between the two structural parts, advantageously can be absorbed by both structural parts, without resulting in fatigue fractures even under prolonged operation. Further, the first structural part or the second structural part can be designed in such a way that stress peaks, caused by the defined irregularity, are comparably transmitted to the first structural part and to the second structural part. For example, in a shaft-hub connection, a material thickness opposite the irregularity may be greater than in regions of the opposite structural part of the shaft or hub adjacent to the irregularity.

In addition, the defined irregularity allows the toothing to be shaped without additional hardening. In this way, it can be ensured that variations from a predetermined profile of the toothing otherwise produced by hardening can be kept small. For example, the structural part may only have the hardness made available by the basic material of the structural part. Optionally, the part may be hardened. Also, surface hardening may be added to this basic hardening. Since the defined irregularity can be obtained before the surface hardening, a variation is produced providing additional influence on the articulated connection, such as in the region of the defined irregularity. The remaining regions of the toothing may have no deformation of any kind. According to one embodiment, the hardening region between 55 RHC and 62 RHC is sought on at least the surface. In particular, two structural parts that have different hardnesses on the surface may be put together. While one structural part has a hardness range of between 55 and 62 RHC, the second structural part has a lower surface hardness. This may for example lie in a range of between 40 and 55 RHC.

Optionally, the toothing has at least two irregularities, which are displaced from each other. For example, the two irregularities may be located opposite each other being displaced by 180°. Further, three or more irregularities may be provided. Also, the irregularities may be distributed in such a way that any stress is distributed equally between the two structural parts. For example, three irregularities can be located at 120° to each other in this instance.

An arrangement of the defined irregularity is influenced by the geometries of the first structural part and of the second structural part and their relationship to each other. Thus, for example, an irregularity in the first structural part is located so that the stress produced in the second structural part does not result in unacceptable damage of the connection or of the structural part and vice versa. If, for example, a spherical hub which has crosspieces is used, the irregularities are located in the region of the respective crosspieces. The shape of the crosspiece prevents expansion of the hub and hence loosening of the connection in operation. Three, five or six crosspieces can be used, with an irregularity being assigned to each crosspiece. Optionally, a tripod is used, as is disclosed for example in DE 4,490,587 and to which reference is made under this disclosure with regard to the tripod and its use.

For example, a toothing may be provided on a surface that is only partially circular. Optionally, the surface may be flat, bent, or at least sectioned. Further, the first or second structural part may have a cross section that is oval, i.e., not circular. Also, a cross-sectional region may be angular.

Optionally, the toothing is partial or segmented, i.e., not continuous, between the first and second structural parts. Also, the toothing may be provided sectionwise. Moreover, the toothing may be provided in a single section. The irregularity may be integrated into the toothing, section, or sectionwise.

Optionally, the defined irregularity in the toothing can be placed in relation to the toothing located outside the irregularity. For example, the toothing of the irregularity varies in at least one parameter in relation to the toothing located outside the irregularity in a range of between 0.1% and 1%. This parameter may be the geometry of a flank, of a tip circle diameter, or of a root circle diameter, and may also be in a gap width or in a gap narrowing.

A tool for the production of at least one structural part of an articulated connection in accordance with the present invention is provided, in which the tool has a matrix with a surface producing a toothing running in a straight line, which has a defined irregularity, where, owing to relative movement between the structural part and the tool, a contour of the irregularity is transferable by the matrix to the structural part, such as a hollow shaft. The tool can be used in a broaching method. Also, the tool may be used in an internal broaching operation or an external broaching operation. Moreover, a broaching movement as is provided in DIN 8589-5 (2003-09) Part 5 may be provided. A variety of procedures are found in this standard, to which reference is made under this disclosure.

The tool can be a multi-toothed broaching tool. In particular, a plurality of cutters may be arranged behind one another in this tool, where the tool may for example be divided into roughing, polishing and calibrating sections, which produce different rise per tooth in each instance. The tool can be capable of being used in such a way that, in a single stroke, the final result of production of toothing running in a straight line having a defined irregularity is obtainable. The matrix of the tool is formed by the cutters. According to one embodiment, a broaching needle is used, which has three unlike teeth inserted behind one another for production of the defined irregularity. The teeth preferably are shaped in such a way that an irregularity, displaced 120° in each instance, is capable of being definably produced on a structural part.

The tool is capable of making an impression of an irregularity, or an impression of an external toothing or internal toothing. The tool can be part of a profile drawing device. The tool may have a length ranging from 100 mm to 2 m. The diameter of the tool may be between 30 mm and 500 mm. Also, the tool may be constructed of multiple parts, such as, a variety of cutting elements brought together in a defined position on a basic member. This makes it possible to replace the cutting elements because of wear, without replacing the basic member.

The tool can be made of high-speed steel. Also, the cutting region may consist of a hardened metal. The tool can be a broaching needle. The tool may be made of structural or heat-treated steel with hard metal cutters welded or bolted thereon. The tool can have a cutting speed of between 1 m/min and 60 m/min. Also, a cooling lubricant may be added during cutting. Optionally, the broaching needle or a broaching bushing may be a one-piece profiled bushing.

Pot broaching can be used for external profiling when a defined irregularity is to be produced, wherein the workpiece executes the cutting movement. There, the workpiece is pressed by a hollow broaching tool, so that all contours to be produced on the periphery of the workpiece can be produced in one stroke. Such a method is disclosed in U.S. Pat. No. 5,507,167, which reference is made to the full extent under this disclosure.

Two tools can be used to advantage. A preliminary contour of a toothing is cut by a first tool, while a final contour, which can form the defined irregularity in the toothing, is cut by a second tool.

Another tool for the production of at least one structural part of an articulated connection in accordance with the present invention is provided, in which one or more rolls are adjustably located on the tool in such a way that they impress a defined irregularity in a profile rolling process on a blank to produce the structural part. The part may be a solid shaft having a toothing running in a straight line. Relative movement between the roll of the tool and a blank results in formation of the toothing and forms the defined irregularity at predetermined defined positions. To make the toothing or defined irregularity, a travel path and pressure generation may be controlled via the roll or the blank in such a way that a variety of contours of teeth are obtainable.

Optionally, the tool has an integrated device for marking a position of the irregularity on the structural part. This may be accomplished by a punch or alternatively by the manner of production of the toothing. Also, the marking may be integrated into the toothing.

A method is provided for the production of an articulated connection of a first structural part with a second structural part by straight-line toothing of internal toothing and external toothing. The first structural part is made from a blank on which an irregularity is impressed, where a position of the irregularity is secured, in order to ensure a defined position of the irregularity in the articulated connection with the second structural part. Accordingly, the first structural part and the second structural part are joined in a defined arrangement. Since force generated by the defined irregularity for the prevention of relative movement between the structural parts causes a stress variation in the structural parts, damage to at least one of the structural parts is prevented. In particular, this makes it possible for a region in which elevated stress peaks occur because of the defined irregularity have stress-reducing dimensionings and/or geometries. The provided position of the first structural part to the second structural part allows joining of the two structural parts while preventing damage to the articulated connection. A marking is impressed on the first structural part, in order to permit identification of the position of the irregularity. This allows for an improved production process. In this connection, a multiplicity of first structural parts can be kept in stock and only when an articulated connection of a first and second structural part is required are they again placed together in a predetermined position and joined. Because the position of the irregularity can be identified, improved production of the articulated connection can be obtained. The method may also be repeated for a structural part having a defined irregularity. Optionally, the position of the defined irregularity, may be accurately indicated by Cartesian coordinates or in the form of a marking reproducing the three-dimensional position of the defined irregularity.

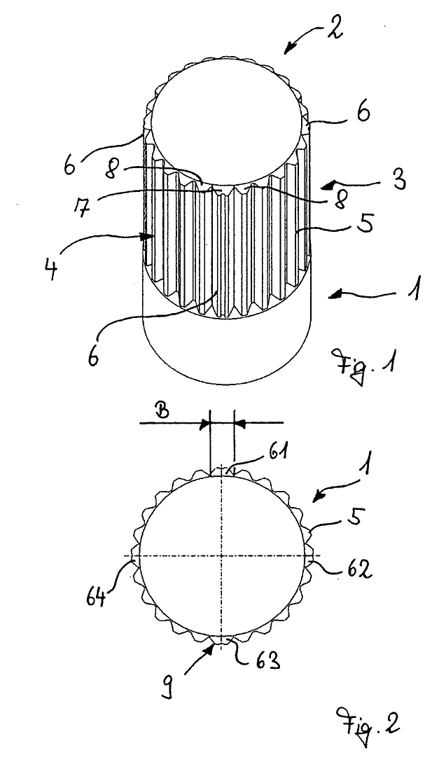

FIG. 1 shows a first structural part 1 having straight toothing 3 and an irregularity 6 in accordance with the present invention. The first structural part 1 is a shaft shank. The straight toothing 3 extends at one end 2 of the first structural part 1. The straight toothing 3 forms an external toothing 4, while a toothing 5 has a defined irregularity 6. The defined irregularity 6 is formed by a tooth 7, whose geometry differs from adjacent teeth 8 of the external toothing 4. The first structural part 1 may be secured by insertion into a second structural part, not represented in detail, because of the securing effect of the defined irregularity 6.

FIG. 2 shows a cross section through the first structural part 1 as shown in FIG. 1. The toothing 5 extends over the periphery of the first structural part 1. Four defined irregularities 6, spaced uniformly apart, are located in the toothing 5. The irregularities 6 have a wider root circle B with respect to adjacent teeth. Optionally, the defined irregularity 6 may be a flank geometry or other dimensioning. A first irregularity 61 can be displaced 90° with respect to a second irregularity 62. The irregularities 63, 64 can also be displaced by 90° with respect to adjacent irregularities, respectively. In this way, a comparable force is obtained for the production of the articulated connection between two structural parts. Optionally, the irregularities 61-64, individually or together, have a marking 9. The marking 9 indicates where the irregularities distributed around the periphery are located on the first structural part 1. The marking 9 may be an indentation, as shown. Optionally, the marking 9 may be an elevation. Also, the marking may be integrated into the defined irregularity 6. Moreover, the marking 9 may be located on a face or at a distance from the toothing 5 of the first structural part 1.

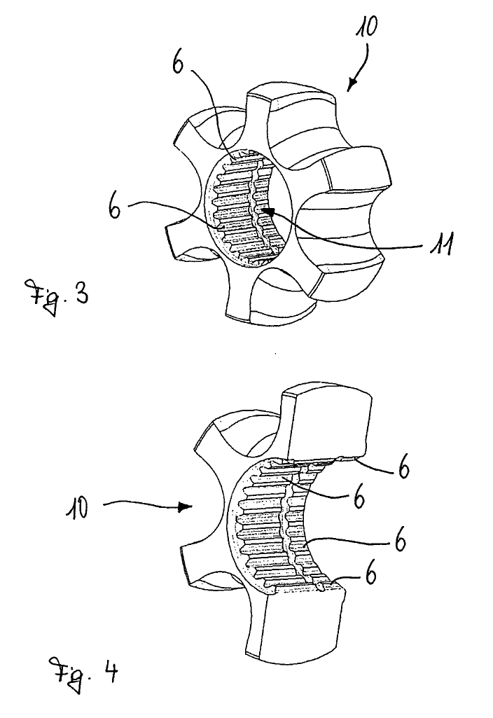

FIG. 3 shows a second structural part 10 having an internal toothing 11 with an irregularity 6 in accordance with the present invention. The second structural part 10 is a spherical hub. Defined irregularities 6 are likewise located in the spherical hub. The defined irregularity 6 may be located on a tooth or formed by a counterpart of a tooth, i.e., by the geometry of a tooth gap into which a tooth of a first structural part projects.

FIG. 4 shows a sectional view through the second structural part 10 shown in FIG. 3. As shown, the second structural part 10 has more than four irregularities. In this example, there are six irregularities. However, these irregularities differ in location and distance apart from each other on the second structural part 10. Optionally, some of the irregularities are evenly distributed. This principle of irregular distribution may be utilized to advantage with the invention.

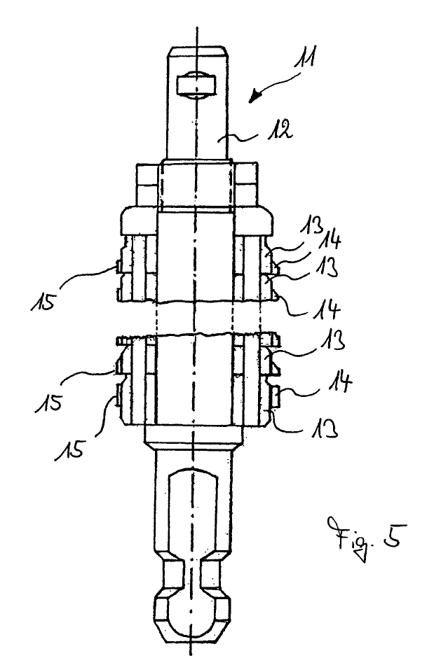

FIG. 5 shows a tool 11 in the form of a broaching needle for the production of a defined irregularity and toothing in accordance with the present invention. Cutting members 13 may be slipped onto and fastened to a basic member 12, which is capable of being fastened in a device. The cutting members 13 form a variety of regions, which are defined by their respective cutters 14. The cutters 14 of a cutting member 13 can have a regularly repeating geometry for the formation of toothing. In particular, the cutter 14 of cutting member 13 provides the formation of a defined irregularity. For this purpose, the cutting member 13 has a cutting geometry 15 adapted to the defined irregularity. Toothing, along with simultaneous formation of a defined irregularity, can be produced by the tool 11 in one work stroke.

FIG. 6 shows exemplary steps of a method for the production of an articulated connection of a first structural part and a second structural part in accordance with the present invention. A blank 16 is held in a workpiece holder 17. This is moved into a working position 18. A broaching needle 19 is guided by the workpiece holder 17 and by the blank 16, so that internal toothing 11 is produced. The broaching needle 19 has a matrix 20, which in addition to the internal toothing 11, also generates a defined irregularity in the internal toothing 11. Since the broaching needle 19 is in a defined position to the workpiece holder 17 and hence to the blank 16, a marking 9 may be placed on the blank 16. Optionally, the relative position of the blank 16 is defined by internal toothing 11 in relation to a structural part to be inserted. The blank 16 with the internal toothing 11 is thus subsequently connected with the second structural part 10, which is connected with the first structural part 1, which has external toothing, for the production of an articulated connection.

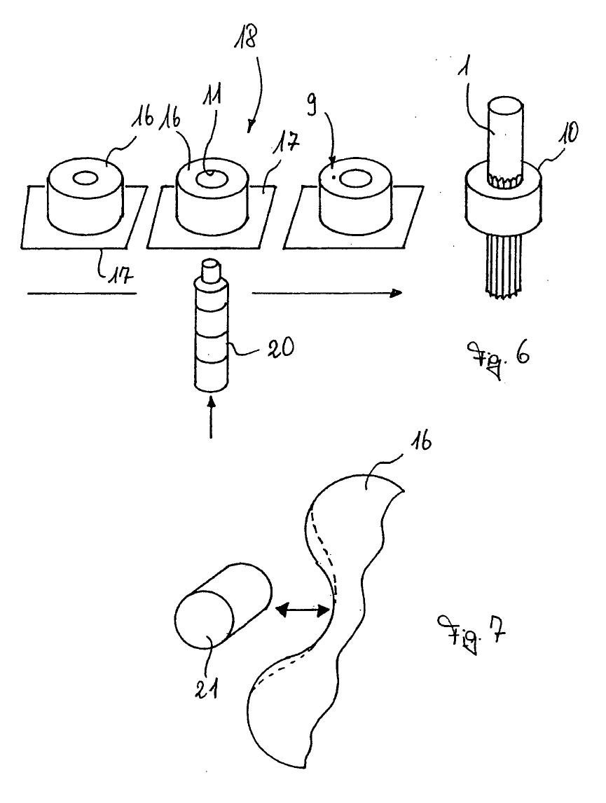

FIG. 7 shows a schematic detail of a rolling method for the production of a defined irregularity in accordance with the present invention. Here, a profile rolling process is used. A roll 21 and a blank 16 are capable of being moved relative to each other, which is indicated by an arrow. In this way, in addition to conventional toothing, a defined irregularity may additionally be applied in the toothing. The defined irregularity is indicated by the dashed line.

FIG. 8 shows a connecting operation of a shaft 22 with a hub 23 in accordance with the present invention. The hub 23 is drawn onto the shaft 22, and a defined force, indicated by the arrows, is applied. The hub 23 is then driven from an initial position S₀ into an end position S₁. The force may be applied to the shaft 22 or to the hub 23.

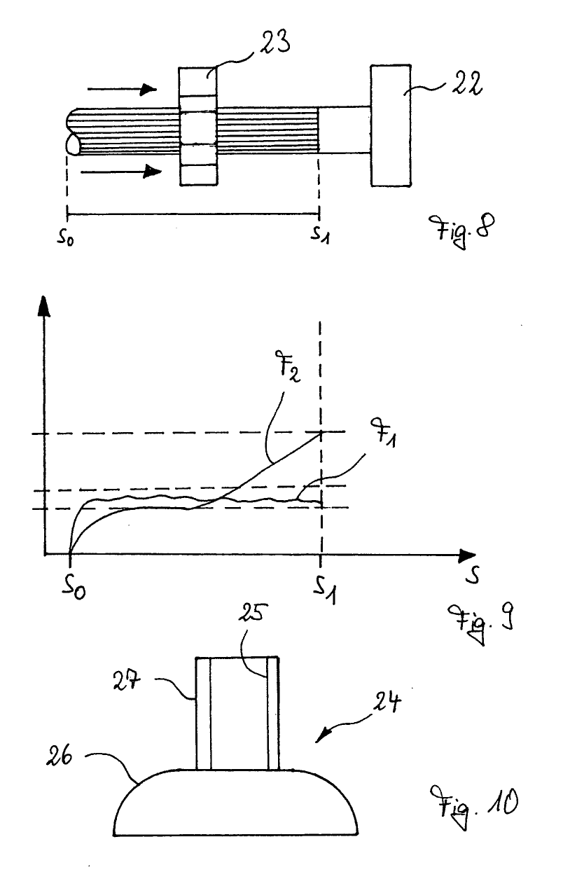

FIG. 9 shows a schematic view of a force variation of the force applied according to the connecting operation as shown in FIG. 8. The force is plotted in the Y direction and the path (S) in the X direction. The path of travel from the initial position S₀ into the end position S₁ is represented. After a chamfer has been overcome with a correspondingly small expenditure of force, the force F₁ to be applied remains, in at least a section, in a corridor that is narrower than the corridor in which a force F₂ travels, which upon joining of the shaft and hub would have to be applied in the case of a twisted toothing. The respective corridors are indicated by dashed lines. In particular, because of the straight toothing, which has a defined irregularity, the force to be applied travels approximately uniformly.

FIG. 10 shows a one-piece articulated part 24 with internal toothing 25 in accordance with the present invention. The articulated part 24 has an arched geometry 26, which is hollow inside, and a bushing 27, into which the internal toothing 25 is inserted, e.g., by a broaching needle. The articulated part 24 may be one piece, where the internal toothing 25 has modified tooth thicknesses or tooth gaps as straight toothing for formation of the defined irregularity.

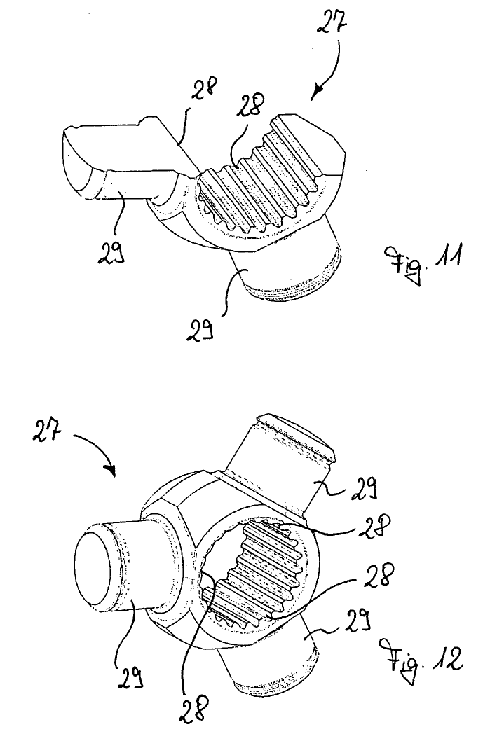

FIGS. 11 and 12 are described together. FIG. 11 shows a partial cross-sectional view of the tripod 27 of FIG. 12. FIG. 12 shows a tripod 27 having internal toothing with three irregularities 28 in accordance with the present invention. Each irregularity being located in the regions of one of the three crosspieces 29, in order to improve strength of the hub. The tripod is used for example in a drive or linkage train of a vehicle.

The articulated connection, utilizing straight toothing between a first structural part and a second structural part, is in advantageous fashion used in a shaft-hub connection. In particular, such an articulated connection finds use in the automotive field, for example in drive shafts. However, the articulated connection may also be used in other vehicles, such as for example ships or trains, or in other applications.

From the foregoing, it can be seen that there has been brought to the art a new and improved connection of two structural parts, including a method and tooling. While the invention has been described in connection with one or more embodiments, it should be understood that the invention is not limited to those embodiments. On the contrary, the invention covers all alternatives, modifications, and equivalents as may be included within the spirit and scope of the appended claims.

1. An articulated connection comprising:
a first structural part having internal toothing; and
a second structural part having external toothing coupled to the internal toothing of said first structural part, wherein at least one of the internal toothing or the external toothing has straight toothing, in which a portion of the straight toothing has a defined irregularity with respect to the remaining portion of the straight toothing, said irregularity producing a force for the prevention of relative movement between said structural parts.

2. The articulated connection according to claim 1, wherein said irregularity comprises an arrangement of one or more teeth or tooth gap sets.

3. The articulated connection according to claim 1, wherein said irregularity has a tooth or a tooth gap flank dimension that differs from a tooth or a tooth gap which is located outside said irregularity.

4. The articulated connection according to claim 1, wherein said first structural part is a hub and said second structural part is a shaft.

5. The articulated connection according to claim 4, wherein the shaft is a hollow shaft.

6. The articulated connection according to claim 1, wherein said irregularity is positionally marked on either of said structural parts.

7. The articulated connection according to claim 1, wherein said straight toothing is provided without additional hardening.

8. The articulated connection according to claim 1, wherein said straight toothing has at least two irregularities.

9. The articulated connection according to claim 8, wherein said irregularities are substantially evenly distributed over the periphery.

10. The articulated connection according to claim 8 wherein said irregularities lie opposite each other.

11. The articulated connection according to claim 1, wherein said defined irregularity has a variation from a second toothing apart from said irregularity, wherein said variation ranges between 0.1% and 1% in relation to at least one varying parameter of said second toothing.

12. The articulated connection according to claim 4, wherein the external toothing has a defined irregularity with respect to the internal toothing, said irregularity producing a force for the prevention of relative movement between said shaft and a hub.

13. The articulated connection according to claim 4, wherein the internal toothing has a defined irregularity with respect to the external toothing, said irregularity producing a force for the prevention of relative movement between said hub and a shaft.

14. A tool for producing a structural part for an articulated connection comprising: a body supporting a matrix having a surface for producing a toothing running in a straight line and a defined irregularity, wherein relative movement between a structural part and said matrix produces said toothing on said structural part.

15. The tool according to claim 14, wherein said body provides an impression of the irregularity when producing said toothing.

16. The tool according to claim 14 wherein said body supporting said matrix is part of a profile drawing process.

17. A tool for producing a structural part for an articulated connection comprising: one or more rolls wherein each of the one or more rolls is adjustably located for impressing an irregularity upon a blank during a profile rolling process substantially creating a straight line toothing for a finished structural part.

18. The tool according to claim 17, further comprising a device for the marking of a position of the irregularity on the structural part.

19. A method for producing an articulated connection having straight-line toothing on a first structural part and a second structural part wherein each of said structural parts, respectively, includes internal toothing and external toothing the method comprising:
supplying a blank;
producing a first structural part having straight-line toothing; and
impressing an irregularity into said first structural part, wherein said irregularity is fixed in a predetermined arrangement for providing an articulated connection with said second structural part.

20. A method according to claim 19, further comprising marking said irregularity on said first structural part.

21. A method according to claim 19, wherein said producing and said impressing is by broaching.

22. A method according to claim 19, further comprising assembling said first structural part to said second structural part with an insertion force ranging between 0.5 kN and 25 kN.

23. The tool according to claim 14, further comprising a device for marking a position of the irregularity on the structural part.

24. The method according to claim 19 further comprising impressing a second irregularity into said second structural part.
